(19) United States
(12) Patent Application Publication
(10) Pub. No.: US 2019/0322538 A1
(43) Pub. Date: Oct. 24, 2019

(54) HIERARCHICAL ZEOLITE-BASED CORE/SHELL NANO- OR MICROCAPSULE

(71) Applicant: SABIC Global Technologies B.V., Bergen op Zoom (NL)

(72) Inventors: Yunyang LIU, Thuwal (SA); Ihab N. ODEH, Sugar Land, TX (US); Nitin CHOPRA, Sugar Land, TX (US)

(21) Appl. No.: 16/475,514

(22) PCT Filed: Jan. 19, 2018
(86) PCT No.: PCT/US2018/014359

§ 371 Date: Jul. 2, 2019

Related U.S. Application Data
(60) Provisional application No. 62/451,107, filed on Jan. 27, 2017.

(51) Int. Cl. C01B 39/38; B01J 13/14; B01J 13/04; C08L 33/02

(52) U.S. Cl. CPC C01B 39/38; B01J 13/14; H01M 10/052; C08L 33/02; B01J 13/043

(57) ABSTRACT

Controlled-release core/shell composite materials and methods of use are described. A composite material can include a hierarchical structured zeolite core having at least a bimodal pore structure with a first active agent loaded into pores of the core, and (b) a porous polymeric outer shell that substantially encompasses the zeolite core. The composite materials can be configured to controllably release the first active agent from the zeolite core and the porous polymeric shell in response to at least one stimulus.

### CROSS REFERENCE TO RELATED APPLICATIONS

This application claims benefit to U.S. Provisional Application No. 62/451,107 filed Jan. 27, 2017, which is incorporated herein by reference in its entirety.

### BACKGROUND OF THE INVENTION

### A. Field of the Invention

The invention generally concerns a controlled-release core/shell composite material that includes a hierarchical structured zeolite core having at least a bimodal pore structure with a first active agent loaded into pores of the core and a porous polymeric outer shell that is in direct contact with and substantially encompasses the zeolite core. The composite material is configured to controllably release the first active agent from the zeolite core and through the porous polymeric shell in response to at least one stimulus. Additionally, the polymer shell itself can be loaded with and hold the active agent(s).

### B. Description of Related Art

Nanostructured encapsulation systems or delivery (e.g., colloidosomes, encapsulated nanoparticles, capsules, and the like) can provide improved uptake and efficient transport or delivery of agents to intended targets (e.g., a person, an animal, an inanimate object, etc.). Capsules provide several advantages, such as protecting the agent from physical or chemical reactions with incompatible ingredients, as well as protecting the agent from volatilization or evaporation. Materials such as chitosan, protein, polymers, and inorganic nanocontainers have been used to encapsulate agents.

By way of example, U.S. Pat. No. 6,221,826 to Surutzidis et al., describes a multi-coated microporous particle that includes laundry agents and perfume. International Patent Application No. WO 2001/040430 to Marin et al., and International Patent Application No. WO 2002/064725 to Dihora et al. each describe delivery systems for additives that include an encapsulated microporous zeolite particle loaded with additives. The agents are released when the particle or delivery agent is dissolved or contacted with water. Gao et al. (J. Phys. Chem. C., 2009, 113:29:12753) and Ziesmer et al. (Colloid and Polymer Science, 2008, 286:6:831) each describe a mesoporous silica core—crosslinked polymeric shell material that is responsive to pH for the controlled uptake and release of agents.

Such core loaded zeolite systems, however, have several limitations. By way of example, these systems tend to have a more spike or burst release profile of the active agent rather than a more controlled and tunable release profile. Further, it is difficult to load multiple active agents into the core and prevent having the agents chemically react or mix with one another. Additionally, the loading capacities of the cores are limited by their core volumes and the composition of the shells can impose thermodynamic limits on the type of actives to be stored. Still further, direct exposure of zeolites in personal care and home products could lead to unwanted reactions with the surfaces that it comes in contact with. In particular, many zeolites are atomically active entities and can react with the chemicals or cause chemical reactions or conversions of chemicals that are present in the surfaces that the zeolites contact.

### SUMMARY OF THE INVENTION

A discovery has been made that solves the aforementioned problems associated with encapsulated zeolite systems having actives loaded within their cores. The solution resides in a core-shell composite material that includes a hierarchical structured zeolite core having active agent(s) loaded therein and a responsive porous polymeric outer shell. In particular, the zeolite core has at least a bimodal pore distribution and the shell substantially encompasses the zeolite core. Active agents can be loaded into the mesopores of the zeolite, the macropores of the zeolite, on the surface of the zeolite, or any combination thereof. This loading structure and capacity of the zeolite core provides for a variety of possible release mechanisms in response to a variety of stimuli (e.g., pH range, electromagnetic radiation, a temperature range, a mechanical force, humidity, the presence or absence of a chemical substance, an odor, or any combination thereof). Additionally, the nanostructured shell can have a single or multi-shell (e.g., layered) architecture, where each shell or layer can also be loaded with an additional active agent or multiple active agents.

The present invention describes controlled-release core/shell composite materials that can include a hierarchical structured zeolite core (e.g., a meso-TSO-1 ; zeolite core, a meso-Silicalite-1 zeolite core, or a ZSM-5 zeolite core) having at least a bimodal pore structure with a first active agent loaded into pores of the core, and a porous polymeric outer shell that substantially encompasses the zeolite core. An overall size of the composite material can range from 0.1 nm to 1000 nm. In some instances, the zeolite core includes at least 80 wt. % of zeolite, based on the total weight of the core, and up to 20 wt. % of active agent, based on the total weight of the core, preferably at least 90 wt. % of zeolite and up to 10 wt. % of active agent, based on the total weight of the core. The composite material is configured to controllably release (including, but not limited to sustained release, a timed release, an extended release, or a slow release) the first active agent from the zeolite core and through the porous polymeric shell. In certain instances, the release of the first active agent (or multiple active agents) can be in response to a given stimulus or stimuli. In other instances, however, the release of the first active agent (or multiple active agents) can occur without the need or presence of a given stimulus or stimuli—it can be released without responding to a given stimulus or stimuli. In some instances, the composite material is comprised in a pharmaceutical composition, a topical skin care composition, a composition intended to be applied to an inanimate object, or an electronic device. Other non-limiting uses are contemplated throughout this application.

The hierarchical structured zeolite core can have at least a bimodal microporous-mesoporous structure. In certain instances, the core can have a bimodal pore distribution structure. In other instances, it can have a trimodal pore distribution structure. In further instances, it can have a tetramodal or more pore distribution structure. In some embodiments, the first active agent can be loaded into the micropores and/or mesopores of the zeolite core. Additional active agents (e.g., 2, 3, 4, 5, etc.) can be loaded into the micropores and/or mesopores of the zeolite core, shell, or combinations thereof. The first and additional active agents can be different active agents. The first active agent and the additional active agent(s) can have different sizes with the first active agent being smaller in size than the additional active agent(s), and/or capable of reacting with one another upon their release from the composite material to form an activated material. Non-limiting examples of active agents include a chemical agent, a biological agent, an oil, an ionic liquid, a suspension, an emulsion, or a polymer, or any combination thereof. Chemical agents can include a drug, a cosmetic agent, a flavoring agent, a fragrance-producing chemical, a malodor agent, a reactive agent, a cross-linker, a reactive diluent, a solvent, an inorganic or organic chemical, a metallo-organic system, a petrochemical, a reducing or oxidizing agent, or an aqueous salt, or any combination thereof. Biological agents can include a protein, a peptide, a nucleic acid, a carbohydrate, a lipid, or any combination thereof.

The outer shell can be a single layer or have multi-layers (e.g., multi-shell). The shell or outer shell can include a polymer network of hydrophilic, hydrophobic, amphiphilic, amphiphobic, lipophilic, lipophobic, oleophilic, or oleophobic polymers, or a combination thereof. In particular instances, at least one of the shell layers is in direct contact with the zeolite core. The porous polymeric shell can include neutral, hydrogen bonded, cationic, anionic, or zwitterionic polymers or polymers comprising metal-organic frameworks or zeolitic imidazolate frameworks. Non-limiting examples of polymers include polyvinyl alcohol (PVA), poly (N-isopropyl acrylamide) (pNIPAAm), poly(ethylene glycol), a poly(methylmethacrylate) (PMMA), a hydroxylated polymethacrylate, an ethylene-vinyl acetate copolymer, polyhydroxyethylmethacrylate, poly(maleic acid/octyl vinyl ether) (PMAOVE), a polyurethane, poly(acrylic acid), poly(stearyl acrylate) (PSA), polystyrene (PS), polyvinylpyrrolidone (PVP), poly(acrylamide), poly(ethylene glycol) methyl ether acrylate, poly(ethylene glycol) methyl ether acrylate and copolymers thereof such as dipropylene glycol acrylate caprylate (DGAC) or dipropylene glycol diacrylate sebacate (DGDS) (a cross-linker), starch, chitosan or a derivative thereof, silicone or a derivative thereof, or a polyolefin, or any combination thereof. In a particular instance, the polymer network includes poly(acrylic acid) or cross-linked polystyrene and the hierarchical structured zeolite core is a ZSM-5 core having a bimodal microporous-mesoporous structure. The shell can be expanded, contracted, constricted, eroded, deformed, reacted, compressed or cyclic compressed, folded, or dissolved in response to the stimulus. Stimulus to trigger release of the active agents can include a pH range, electromagnetic radiation, a temperature range, a mechanical force, humidity, the presence or absence of a chemical substance, an odor, electrical charge, electrostatic charge, or any combination thereof.

In some embodiments, the zeolite core and/or the polymeric shell is/are functionalized by silane coupling agents. Silane coupling agents can include a silane reagent with amino, hydroxyl, vinyl, allyl, epoxyl, etc., functional group. Non-limiting examples of silane regents can include triethoxyvinylsilane, (3-aminopropyl)triethoxysilane, (3-glycidyloxypropyl)trimethoxysilane, allyltrimethoxysilane, allyltriethoxysilane, trimethoxymethylsilane, 1H,1H,2H,2H-perfluorodecyltriethoxysilane, ethynyltrimethylsilane and 3-(trimethoxysilyl)propyl methacrylate (also known as 3-(methacryloyloxy)propyltrimethoxysilane), (3-mercaptopropyl)trimethoxysilane, (3-chloropropyl)trimethoxysilane, trimethoxy(3,3,3-trifluoropropyl)silane and the like. Examples of amines, thiols, esters, ketonic, alkyl regents are silane coupling agents with amino, mercapto group, ester ketonic and alkyl. Non-limiting examples of such agents are triethoxyvinylsilane, (3-aminopropyl)triethoxysilane, (3-glycidyloxypropyl)trimethoxysilane, allyltrimethoxysilane, allyltriethoxysilane, trimethoxymethylsilane, 1H,1H,2H,2H-perfluorodecyltriethoxysilane, etc.

Other embodiments of the invention describe methods of using the controlled-release core/shell composite material(s) of the present invention to deliver an active agent. Methods can include subjecting the composite material to a stimulus to release and deliver the active agent. In some instances, the agent can be controllably released from the composite material. The composite material can be comprised in a composition and be topically, transdermally, or orally administered to a subject, or be applied to a surface of an inanimate object.

In still other embodiments, methods of making the controlled-release core-shell composite material of the present invention are described. Methods can include obtaining a hierarchical structured zeolite core having at least a bimodal pore structure, and loading the zeolite core with an active agent prior to or after forming a porous polymer shell. Forming the porous polymer shell can include coating the zeolite core with a polymer containing solution followed by drying the coated zeolite core. In some embodiments, forming the porous polymer shell can include coating the zeolite core with a monomeric containing solution, polymerizing the monomers to form a polymer coating on the zeolite core, and then drying the coated zeolite core. In certain instances, the polymer or monomer containing solutions can further include nanostructures, preferably inorganic nanostructures. The nanostructures can ultimately be comprised within the formed polymer coating (e.g., whether from drying a polymer solution or polymerizing a monomeric solution followed by drying), and can be partially or fully etched away from the dried polymer coating to form a porous coating.

In a particular aspect of the invention, 22 embodiments are described. Embodiment 1 is a controlled-release core/shell composite material comprising: (a) a hierarchical structured zeolite core having at least a bimodal pore structure with a first active agent loaded into pores of the core; and (b) a porous polymeric outer shell that substantially encompasses the zeolite core, wherein the composite material is configured to controllably release the first active agent from the zeolite core and the porous polymeric shell in response to at least one stimulus. Embodiment 2 is the controlled-release core/shell composite material of embodiment 1, wherein the hierarchical structured zeolite core has a bimodal microporous-mesoporous structure. Embodiment 3 is the controlled-release core/shell composite material of embodiment 2, wherein the first active agent is loaded into the micropores and/or mesopores of the zeolite core. Embodiment 4 is the controlled-release core/shell composite material of any one of embodiments 2 or 3, further comprising at least one additional active agent wherein the first active agent and at least one additional active agent are each loaded into the micropores and/or mesopores of the zeolite core, the shell or combinations thereof, and wherein the first and the additional active agent are: (i) different active agents; (ii) have different sizes with the first active agent being smaller in size than the second active agent; and/or (iii) capable of reacting with one another upon their release from the composite material to form an activated material. Embodiment 5 is the controlled-release core/shell composite material of any one of embodiments 1 to 4, wherein the hierarchical structured zeolite core is a meso-titanium silicate-1 (TS-1) zeolite core, a meso-silicalite-1 zeolite core, or a ZSM-5 zeolite core. Embodiment 6 is the controlled-release core/shell composite material of any one of embodiments 1 to 5, wherein the zeolite core and/or the polymeric shell is/are functionalized. Embodiment 7 is the controlled-release core/shell composite material of embodiment 6, wherein the zeolite core and/or the polymeric shell is/are functionalized with a silane reagent, amine reagent, thiol reagent, ester reagent, ketonic reagent, alkyl reagent, or combinations thereof, preferably, with at least one silane reagent selected from the group consisting of triethoxyvinylsilane, (3-aminopropyl)triethoxysilane, (3-glycidyloxypropyl)trimethoxysilane, allyltrimethoxysilane, allyltriethoxysilane, trimethoxymethylsilane, 1H,1H,2H,2H-perfluorodecyltriethoxysilane, ethynyltrimethylsilane, and 3-(trimethoxysilyl)propyl methacrylate. Embodiment 8 is the controlled-release core/shell composite material of any one of embodiments 1 to 7, wherein the porous polymeric shell comprises a polymer network of hydrophilic, hydrophobic, amphiphilic, amphiphobic, lipophilic or lipophobic, oleophilic or oleophobic polymers, or a combination thereof. Embodiment 9 is the controlled-release core/shell composite material of embodiment 8, wherein the polymer network comprises polyvinyl alcohol (PVA), poly (N-isopropyl acrylamide) (pNIPAAm), poly(ethylene glycol), a poly(methylmethacrylate) (PMMA), a hydroxylated polymethacrylate, an ethylene-vinyl acetate copolymer, polyhydroxyethylmethacrylate, poly(maleic acid/octyl vinyl ether) (PMAOVE), a polyurethane, poly(acrylic acid), poly(stearyl acrylate) (PSA), polystyrene (PS), polyvinylpyrrolidone (PVP), poly(acrylamide) Poly(ethylene glycol) methyl ether acrylate, Poly(ethylene glycol) methyl ether acrylate and copolymers thereof such as dipropylene glycol acrylate caprylate (DGAC) or dipropylene glycol diacrylate sebacate (DGDS) (a cross-linker), starch, chitosan or a derivative thereof, silicone or a derivative thereof, or a polyolefin, or any combination thereof. Embodiment 10 is the controlled-release core/shell composite material of embodiment 9, wherein the polymer network comprises poly(acrylic acid) and the hierarchical structured zeolite core is a ZSM-5 core having a bimodal microporous-mesoporous structure. Embodiment 11 is the controlled-release core/shell composite material of any one of embodiments 9 to 10, wherein the polymeric network comprises neutral, hydrogen bonded, cationic, anionic, or zwitterionic polymers or polymers comprising metal-organic frameworks or zeolitic imidazolate frameworks. Embodiment 12 is the controlled-release core/shell composite material of any one of embodiments 1 to 11, wherein the at least one stimulus is a pH range, electromagnetic radiation, a temperature range, a mechanical force, humidity, the presence or absence of a chemical substance, an odor, electrical charge, electrostatic charge, or any combination thereof. Embodiment 13 is the controlled-release core/shell composite material of any one of embodiments 1 to 12, wherein the shell is capable of expanding, contracting, constricting, eroding, deforming, reacting, compressing or cyclic compressing, folding, or dissolving in response to the stimulus. Embodiment 14 is the controlled-release core/shell composite material of any one of embodiments 1 to 13, wherein the active agent is a chemical agent, a biological agent, an oil, an ionic liquid, a suspension, an emulsion, or a polymer, or any combination thereof. Embodiment 15 is the controlled-release core/shell composite material of embodiment 14, wherein: the chemical agent is a drug, a cosmetic agent, a flavoring agent, a fragrance-producing chemical, a malodor agent, a reactive agent, a cross-linker, a reactive diluent, a solvent, an inorganic or organic chemical, a metallo-organic system, a petrochemical, a reducing or oxidizing agent, or an aqueous salt, or any combination thereof; and/or the biological agent is a protein, a peptide, a nucleic acid, a carbohydrate, a lipid, or any combination thereof. Embodiment 16 is the controlled-release core/shell composite material of any one of embodiments 1 to 15, wherein the composite material is comprised in a pharmaceutical composition, a topical skin care composition, a composition intended to be applied to an inanimate object, or an electronic device. Embodiment 17 is the controlled-release core/shell composite material of any one of embodiments 1 to 16, wherein the zeolite core comprises at least 80 wt. % of zeolite, based on the total weight of the core, and up to 20 wt. % of active agent, based on the total weight of the core, preferably at least 90 wt. % of zeolite and up to 10 wt. % of active agent, based on the total weight of the core.

Embodiment 18 is a method of using the controlled-release core/shell composite material of any one of embodiments 1 to 17 to deliver an active agent, the method comprising subjecting the composite material to a stimulus to release and deliver the active agent.

Embodiment 19 is a device comprising a sulfur-containing active agent loaded core/shell composite material. Embodiment 20 is the device of embodiment 19, wherein the device is a lithium sulfide battery.

Embodiment 21 is a method of making the controlled-release core/shell composite material of any one of embodiments 1 to 17, the method comprising: (a) obtaining a hierarchical structured zeolite core having at least a bimodal pore structure; and (b) loading the zeolite core with an active agent prior to or after forming a porous polymer shell. Embodiment 22 is the method of embodiment 21, wherein forming the porous polymer shell comprises: (i) coating the zeolite core with a polymer containing solution followed by drying the coated zeolite core to form the core/shell composite material and/or (ii) coating the zeolite core with a monomeric containing solution, polymerizing the monomers to form a polymer coating on the zeolite core, and then drying the coated zeolite core.

The following includes definitions of various terms and phrases used throughout this specification.

“Controlled release” or “controllably release” refers to the ability of the composite material of the present invention to gradually release active agent(s) from the material over a period of time. This can also be referred to as a sustained release, a timed release, an extended release, or a slow release. By way of example, the active agent(s) can be controllably released from the composite material into the surrounding area or medium such that the majority of the active agent(s) is released after a certain time period (e.g., after 5, 10, 20, 30, 40, 50, 60, 90, 120, 150, 180, 210, or 240 minutes or longer). In certain instances, the release of the active agent can be in response to a given stimulus or stimuli. In other instances, however, the release of the active agent can occur without the need or presence of a given stimulus or stimuli.

“Nanostructure” or “nanomaterial” refer to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 100 nm (e.g., a first dimension is 1 to 100 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof “Nanoparticles” include particles having an average diameter size of 1 to 1000 nanometers.

The “core/shell” phrase encompasses both core/shell and yolk/shell structures, with the difference being that in a core/shell structure at least 50% of the surface of the “core” contacts the shell. By comparison, a yolk/shell structure includes instances where less than 50% of the surface of the “yolk” contacts the shell. In some preferred aspects, a core/shell structure where at least 50% of the surface of the core contacts the shell is used.

Determination of whether a core, yolk, or void space is present in the core/shell structures or materials of the present invention can be made by persons of ordinary skill in the art. One example is visual inspection of a transition electron microscope (TEM) or a scanning transmission electron microscope (STEM) image of a core/graphene based shell structure or material of the present invention and determining whether a void space is present or determining whether at least 50% (core) or less (yolk) of the surface of a given core that contacts the shell.

“Mesopore” or “mesopores” refers to a pore or pores having an average pore diameter of 2 to 50 nm (20 Å to 500 Å).

“Micropore” or “micropores” refer to a pore or pore having an average pore diameter that does not exceed 2 nm (20 Å). Bimodal distribution of pores has two distinct peak heights with one peak.

The phrase “bimodal microporous-mesoporous structure” or “bimodal pore distribution” refers to a pore size distribution that have two distinct distribution curves. Similarly, trimodal, tetramodal, etc. refer to 3, 4, etc. distinct distribution curves. The Brunauer-Emmett-Teller (BET) surface area and pore distribution can be determined using nitrogen physisorption isotherms using a model of mesopore size dependence on the equilibrium gas pressure (Barrett-Joyner-Halenda model, BJH method) or a combination of BJH method and Horvath±Kawazoe (HK) calculation. The method of Dombrowski et al. (Studies in Surface Science and Catalysis, 2002, Vol. 144, pages 99-106) can be used. In a particular instances, this measurement can occur at 77 K on an automatic volumetric adsorption apparatus (Micromeritics ASAP 2420, Micromeritics, USA). The samples can be filled into glass ampoules and outgassed in high vacuum at 473 K for 24 h before the start of the sorption measurements.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The controlled-release core/shell composite material of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the core/shell composite materials of the present invention of the present invention is their ability to contain and release active agents from their core in response to a stimulus or multiple stimuli.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIGS. 1A-1F depict schematics of various controlled-release core/shell composite materials of the present invention.

FIG. 2 depicts a method of preparing a controlled-release core/shell composite materials of the present invention.

FIG. 3 depicts another method of preparing a controlled-release core/shell composite materials of the present invention.

FIG. 4 depicts another method of preparing a controlled-release core/shell composite materials of the present invention that includes a linker material.

FIGS. 5A and 5B show scanning electron microscopy (SEM) of meso-ZSM-5 of the present invention (5A) before and (5B) after.

FIG. 6 shows an energy-dispersive X-ray spectroscopy (EDS) pattern for the meso-ZSM-5 of the present invention.

FIG. 7 shows an X-ray diffraction pattern of the meso-ZSM-5 of the present invention.

FIG. 8 shows a nitrogen absorption-desorption isotherm of meso-ZSM-5 of the present invention.

FIG. 9 shows a Pore size distributions of meso-ZSM-5 of the present invention.

FIG. 10 shows FT-IR spectra of meso-ZSM-5 and modified meso-ZSM-5.

FIGS. 11A and 11B show SEM images of (11A) meso-ZSM-5 and (11B) meso-ZSM-5@PS of the present invention.

FIGS. 12A and 12B show transmission electron microscopy (TEM) images of (12A) meso-ZSM-5@PS and (12B) magnified portion of meso-ZSM-5@PS of the present invention.

FIG. 13 shows FT-IR spectra of polystyrene (PS), meso-ZSM-5 of the present invention and meso-ZSM-5@PS of the present invention.

FIG. 14 shows a thermogravimetric plot of limonene loaded meso-ZSM-5@PS of the present invention.

While the invention is susceptible to various modifications and alternative forms, specific embodiments thereof are shown by way of example in the drawings. The drawings may not be to scale.

### DETAILED DESCRIPTION OF THE INVENTION

A solution to the problems associated with controllable release of active agents in response to a stimulus or multiple stimuli has been discovered. The solution is premised on loading active agent(s) into the hierarchical structured zeolite cores of the composite materials of the present invention, and optionally in the shell of the composite material. This is in contrast to conventional controlled release materials, which encapsulate the active agent in mesopores of a zeolite. The solution provides an elegant way to allow for tuning of the composite material for one or more specific applications. By way of example, the porous polymer shell can be tuned to allow for one or more kind of triggered-release mechanism(s) such as pH, temperature, light, vapor pressure or odor, light, humidity, mechanical force, and/or chemical environment (e.g., biomarkers, sweat, salt/electrolyte gradient, etc.) electrical charge, electrostatic charge and/or one or more kind of storage systems of one or more active agents. In further instances, and without wishing to be bound by theory, it is believed that bimodal zeolites can hold compounds with different molecular weight and the release of small molecule can be slower than with a mesoporous zeolite.

These and other non-limiting aspects of the present invention are discussed in further detail in the following sections and the accompanying figures.

### A. Controlled-Release Core/Shell Composite Material

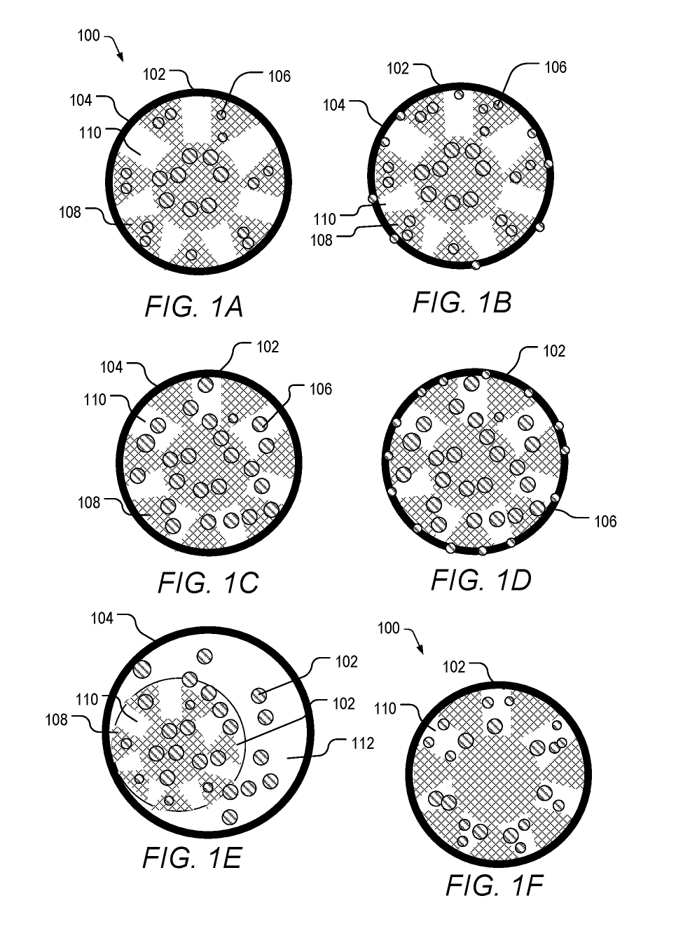

The composite material of the present invention can include a responsive shell encompassing a hierarchical zeolite core loaded with an active agent that is capable of being released from the core. FIGS. 1A-1F are schematics of the composite materials of the present invention. Referring to the FIGS., composite material 100 includes hierarchical core 102, shell 104, and agents 106. Hierarchical core 102 includes micropores 108 and mesopores 110. FIG. 1A depicts agents 106 loaded in micropores 108 of zeolite core 102. FIG. 1B depicts agents 106 loaded in micropores 108 and shell 104 of composite material 100. FIG. 1C depicts agents 106 loaded in mesopores 110 and micropores 108 of the zeolite core 102. FIG. 1D depicts agents 106 loaded in micropores 108, mesopores 110, and shell 104 of composite material 100. FIG. 1E depicts core 102 as a yolk-type structure (i.e., less than 50% of the outer surface of the core contacting the shell) with agents 106 positioned in micropores 108, mesopores 110, and the void space 112 between yolk/core 102 and the inner portion of shell 104. FIG. 1F depicts agents 106 loaded in mesopores 110 of composite material 100. It should be understood that other types of structures are also contemplated. For example, agents 106 loaded into mesopores 110 and shell 104, or yolk-type structures with agents only in the micropores, agents in micropores, mesopores, and shell, agents in the micropores and shell, agents in the mesopores and shell. Zeolite core 102 can include at least 80 wt. % of zeolite, at least 81 wt. %, at least 82 wt. %, at least 83 wt. %, at least 84 wt. %, at least 85 wt. %, at least 86 wt. % at least 87 wt. %, at least 88 wt. %, at least 89 wt. %, at least 90 wt. %, at least 91 wt. %, at least 92 wt. %, at least 93 wt. %, at least 94 wt. %, at least 95 wt. %, at least 96 wt. %, at least 97 wt. %, at least 99 wt. %, at least 99.9 wt. % of zeolite or any value or range there between, based on the total weight of the zeolite core. Zeolite core 102 can include up to 20 wt. % of agent(s) 106, or 0.001 wt. %, 0.01 wt. %, 0.1 wt. %, 0.5 wt. %, 1 wt. %, 2 wt. %, 3 wt. % 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. % of agent(s) or any range or value there between, based on the total weight of the zeolite core. In some embodiments, zeolite core 102 includes at least 80 wt. % of zeolite and up to20 wt. % of active agent(s) 106, based on the total weight of the zeolite core. In a preferred embodiment, zeolite core 102 include at least 90 wt. % of zeolite and up to 15 wt. % of active agent(s) 106, based on the total weight of the zeolite core. The composite material can have a size of at least, equal to, or between any two of 0.1 nm, 0.5 nm, 10 nm, 100 nm, and 1000 nm. In some embodiments, the size is from 0.1 nm to 1000 nm, 0.5 nm to 100 nm, 1 nm to 10 nm or any value or range there between. The core and shell can be made from any materials described throughout the specification. In a preferred embodiment, the composite material includes a poly(acrylic acid) shell and a ZSM-5 core having a bimodal microporous-mesoporous structure. In another preferred embodiment, the composite material includes a cross-linked polystyrene shell and a ZSM-5 core having a multi-modal (e.g., microporous, mesoporous and macroporous structure. In a particular instance, the composite material includes a cross-linked polystyrene shell and a ZSM-5 core has a bimodal microporous-mesoporous structure.

1. Hierarchical Zeolite Core

Hierarchical zeolite core 102 has micropores 108 and mesopores 110. In certain non-limiting aspects, micropores can have an average pore diameter from 0.01 nm to 1.99 nm, 0.05 nm to 1.8 nm, 0.1 nm to 1.5 nm, 0.5 nm to 1.25 nm, 0.75 nm to 1.0 nm or any range or value there between. Mesopores can have an average pore diameter of 2 nm to 50 nm, 2.5 nm to 45 nm, 3 nm to 40 nm, 3.5 nm to 35 nm, 4 nm to 30 nm, 4.5 nm to 25 nm, 5 nm to 20 nm, 5.5 nm to 15 nm, 6 nm to 10 nm or any range or value there between. The distribution of the micropores and mesopores can be bimodal, trimodal, tetramodal, etc. In certain non-limiting instances, the pore volume of the hierarchical zeolite core can be 0.4 to 1 cm³/g. In other non-limiting instances, at least 10% of the pore volume present can be mesopores and at least 10% of the pore volume present can be micropores. In still another non-limiting embodiment, at least about 2% of the pore volume present can be pores have diameter greater than 50 nm

In some embodiments, hierarchical zeolite core 102 and/or shell 104 can be functionalized. Functionalization of the core can assist in attaching one or more polymeric layers to the zeolite structure. Non-limiting examples of functionalization agents include a silane agent, an amine reagent, a thiol reagent, an ester reagent, a ketonic reagent, an alkyl reagent, or combinations thereof. In some embodiments, the zeolite core can be reacted with a silane reagent to form a silane functionalized zeolite core compound. The silane reagent has two functional groups, one to bond with the zeolite and one functional group to bond with the polymer. The silanated zeolite can then be reacted with the organic polymer to covalently bond the polymer with the silane-functionalized zeolite to produce a polymer coated zeolite. In the alternative, the polymer material of the shell can be reacted with a silanated agent and then attached to the zeolite core. Non-limiting examples of silanation reagents include triethoxyvinylsilane, (3-aminopropyl)triethoxysilane, (3-glycidyloxypropyl)trimethoxyilane, allyltrimethoxysilane, allyltriethoxysilane, trimethoxymethylsilane, 1H,1H,2H,2H-perfluorodecyltriethoxysilane, ethynyltrimethylsilane, 3-(trimethoxysilyl)propyl methacrylate, octadecyltrichlorosilane (OTS) and (3-mercaptopropyl)-trimethoxysilane (MPTS). In other embodiments, the hierarchical zeolite core can be prepared by crystallization of a silanized protozeolitic unit from organosilanes. In some embodiments, the size of the mesopores can be tuned based on the organosilane used to prepare the zeolite.

2. Porous Polymeric Shell

Porous polymeric outer shell 104 can substantially encompass zeolite core 102. In some embodiments, one or more polymer layers can exist between the outer shell 104 and core 102. By way of example, 2, 3, 4, 5 or more layers can be positioned between the surface of the zeolite core 102 and the inner surface of shell 104. In a preferred embodiment, the inner surface of outer shell 104 is directly attached to the outer surface of zeolite core or attached via a covalently bonded linker (e.g., silane linker). In some embodiments, the porous polymeric outer shell includes polymers and polyelectrolytes.

The shell 104 can be capable of expanding, contracting, constricting, reacting, folding, reversing its surface charge (e.g., from negative to positive), dissolving (partially or fully), compressing (squeezing), or cyclic compressing in response to a stimulus to release the active agent from the shell. In some embodiments, porous polymer shell 104 can be grafted or functionalized such that the pores of the shell open and close in response to a stimulus or multiple stimuli. By way of example, the shell can expand when contacted with water (e.g., water droplets, moisture, vapor, condensate, etc.), change its surface charge from negative to positive at a specific pH, or respond to a change in temperature or a temperature range (e.g., from 10-100° C.), or be able to be squeezed in a cyclic manner. The shell can be tuned to release the active agent and an additional (e.g. a second) active agent in response to the same or different stimuli. The porous outer shell 104 can be a polymer network of hydrophilic, hydrophobic, amphiphilic, amphiphobic, lipophilic, lipophobic, oleophilic, or oleophobic polymers, or a combination thereof.

### B. Preparation of Controlled-Release Core/Shell Composite Materials of the Present Invention

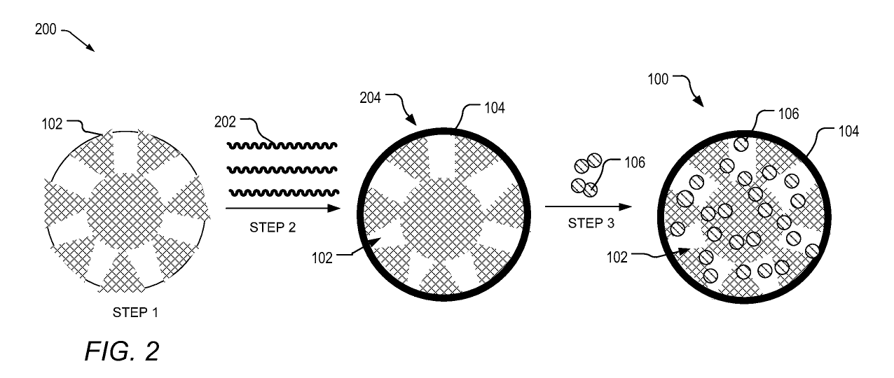

FIGS. 2-4 are schematics of methods 200, 300, and 400 of preparing controlled-release core/shell composite materials 100 of the present invention. The methods can include one or more steps that can be used in combination to make the composite material. Referring to FIG. 2, step 1 of method 200 includes obtaining hierarchical zeolite core 102 having at least a bimodal distribution pore structure. Hierarchical zeolite core 102 can be purchased from commercial vendors, made as exemplified in the Examples, or described throughout the specification. In step 2, hierarchical zeolite core 102 can be coated with polymer or monomer containing solution 202 to form coated zeolite core. The coated zeolite core can be dried to remove the solution and form a core/shell structure 204. In instances when monomers are used, the coated zeolite core can be subjected to polymerization conditions (e.g., heat, electromagnetic radiation, or plasma) to polymerize to the monomer solution and form a polymeric coating. In step 3, agents 106 can be loaded into the core/shell structure using impregnation techniques or the like to produce controlled-release core/shell composite material 100 having hierarchical zeolite core 102, shell 104 and agents 106. Agents 106 can be loaded by using the following non-limiting methods: electrophoretic; diffusive; osmotic; and/or transport of species across the porous shell. In one non-limiting embodiment, the powder or a suspension can be immersed in the solution of agent and allowed to uptake for several min to hrs. Once the uptake duration is over, the suspension can be filtered, centrifuged, or sedimented to remove excess agent and collect the loaded delivery agents.

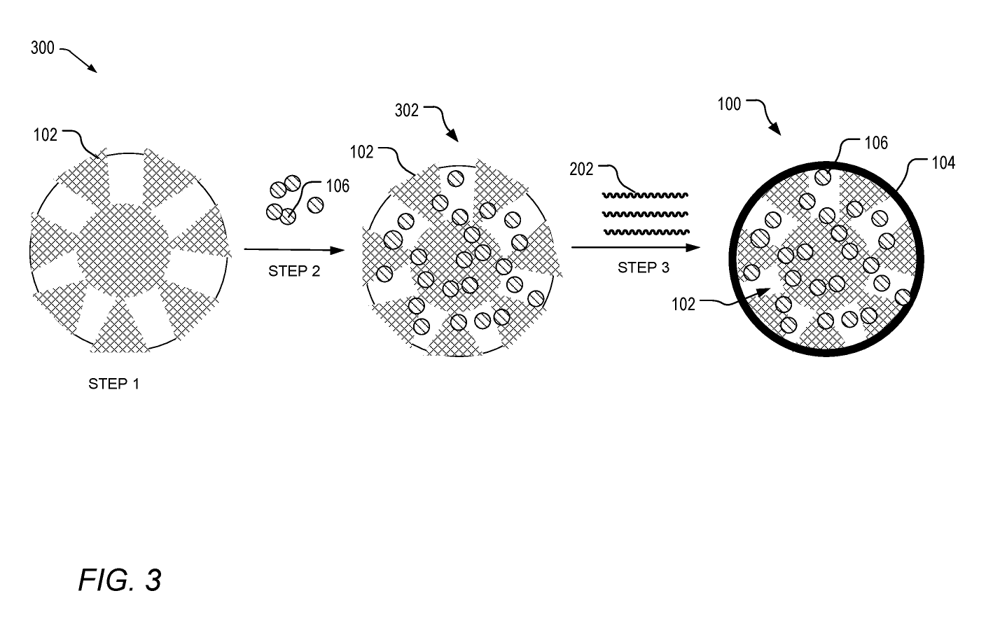

Referring to FIG. 3 as schematic of method 300 of preparing the controlled-release core/shell composite material 100 is depicted. In step 1 of method 300, hierarchical zeolite core 102 having at least a bimodal distribution pore structure can be obtained. In step 2, agents 106 can be loaded into the hierarchical core structure 102 using impregnation techniques or the like to form agent/core structure 302. By way of example, hierarchical core structure 102 and agents 106 can be dispersed in a solvent (e.g., organic or water) under agitation (e.g., ultrasonication). The dispersion can be subjected to reduced pressure to load agents 106 into the pores of the hierarchical core structure. The loadings can be done at any temperature that does not decompose the agent. By way of example, the loading can be done at 15° C. to 100° C. Agent/core structure 302 can be contacted with polymer or monomer solution 102 to a form coated agent/zeolite structure. The coated agent/zeolite structure can be dried to remove the solution and form core/shell structure 100. Drying temperatures can range from 30 to 100° C., 40 to 80° C., or 50to 70° C. or any range or value there between. In instances when monomers are used, the coated agent/zeolite structure can be subjected to polymerization conditions (e.g., heat, electromagnetic radiation, or plasma) to polymerize to the monomer solution and form a polymeric coating on the zeolite core, which can then be dried to produce the core/shell composite material of the present invention.

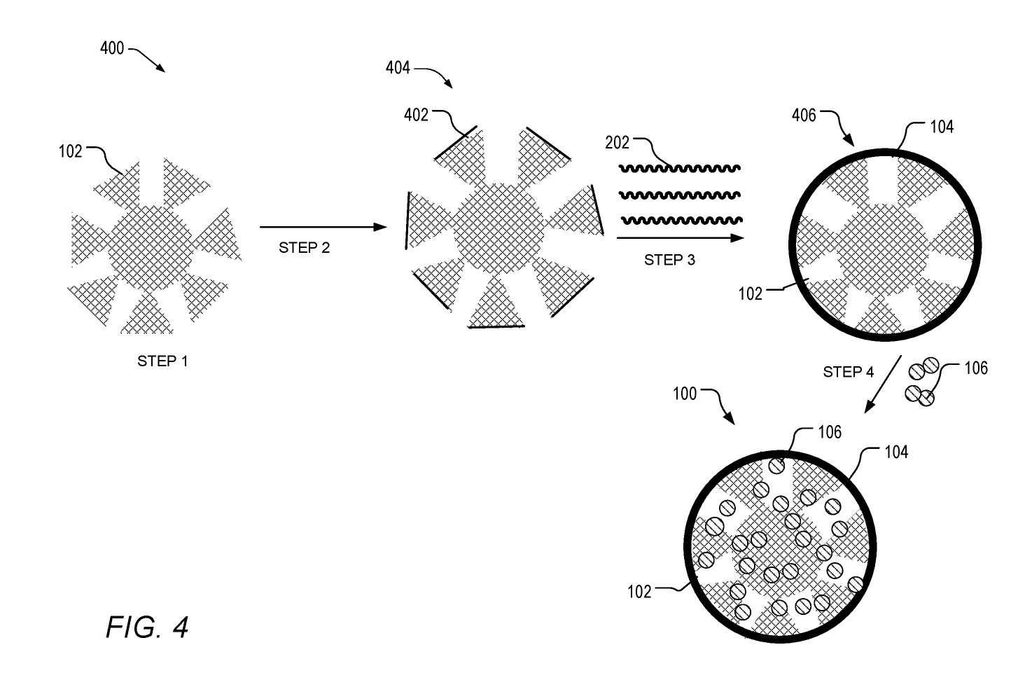

Referring to FIG. 4, step 1 of method 400 includes obtaining hierarchical zeolite core 102 having at least a bimodal distribution pore structure. Hierarchical zeolite core 102 can be purchased from commercial vendors, made as exemplified in the Examples, or described throughout the specification. In step 2, hierarchical zeolite can be modified with covalent linker 402 and form modified hierarchical zeolite 404, having hierarchical zeolite core 102 and covalent linker 402. In step 3, modified hierarchical zeolite core 404 can be coated with polymer or monomer containing solution 202 to form a coated zeolite core where the polymer shell 104 is attached to the core 102 through the linker. The coated zeolite core can be dried to remove the solution and form a core/shell structure 406. In instances when monomers are used, the coated zeolite core can be subjected to polymerization conditions (e.g., heat, electromagnetic radiation, or plasma) to polymerize to the monomer solution and form a polymeric coating. In step 4, agents 106 can be loaded into the core/shell structure using impregnation techniques or the like to produce controlled-release core/shell composite material 100 having hierarchical zeolite core 102, shell 104 and agents 106. Agents 106 can be loaded by using the following non-limiting methods: electrophoretic; diffusive; osmotic; and/or transport of species across the porous shell. In one non-limiting embodiment, the powder or a suspension can be immersed in the solution of agent and allowed to uptake for several min to hrs. Once the uptake duration is over, the suspension can be filtered, centrifuged, or sedimented to remove excess agent and collect the loaded delivery agents. In some embodiments, the agents are loaded as described in FIG. 3 prior to or after modifying the core with the linker.

In some embodiments, the polymer or monomer solution includes nanostructures that can be later removed to form pores in outer shell 104 to increase or provide porosity in the shell. Once the polymer coating has been formed the nanostructures (e.g., metal oxides, silica and/or alumina) can be etched from the polymer coating to form pores. The pores and/or the surface of the shell can be functionalized to introduce a trigger receptor that can react to a stimulus or multiple stimuli to release the agent from the core/shell structure. The size of nanostructures can range from 0.5 nm to 200 nm, 1 to 100 nm, or about 100 nm. The nanostructures can be any shape. Tuning the shape of the pore can provide selective transport in and out of the core/shell composite material.

### C. Materials

1. Hierarchical Zeolites

Non-limiting examples of materials that can be used as hierarchical zeolite core 102 include meso-titanium silicate-1 (TS-1), a meso-silicalite-1, or a ZSM-5. The hierarchical zeolite material can be made using methods known in the art (e.g., Tian et al. Adv. Funct. Mater. 2016, 25:1881-9) (“Tian et al.”) or Zhou et al. (“Synthesis of mesoporous ZSM-5 zeolite crystals by conventional hydrothermal treatment.” RSC Advances 2013, 3(36): 15596-15599), as exemplified in the Examples section, or purchased from commercial vendors such as Sigma-Aldrich®, St. Louis, Mo., U.S.A.

Hierarchical zeolite TS-1 can have a Si/Ti ratio of 20 to 80 (20:80), preferably 60. An aqueous solution of base (e.g., NaOH) and a templating agent (e.g., poly(N₁,N₁-diallyl-N₁-methyl-N₆,N₆,N₆-tripropylhexane-1,6-diamonium bromide (PDAMAB-TPHAB)) in a 0.3 to 0.5 w/w ratio can be obtained. A silicon source (e.g., tetraethyl orthosilicate (TEOS) and a titanium source (e.g., tetrabutyl orthotitante (TBOT) can be added to the aqueous solution at a temperature of 50° C. to 100° C. until a gel forms. In some embodiments, the molar composition of the mixture can be 1 PDAMAB-TPHAB:20 SiO₂: 2.5 Na₂O: 0.33 TiO₂: 800 H₂O. The resulting gel can then heated under hydrothermal (e.g., autogenous) conditions to crystalize the zeolite. For example, the gel can be heated at 145 to 160° C. under pressure for about 30 to 50 hours. The solution can be cooled to produce a templated zeolite. The polymer template can be removed by calcination at 500 to 600° C. to produce a TS-1 zeolite having a mesoporous-microporous structure. Hierarchical silicalite-1 and hierarchical ZSM-% can be synthesized in a manner similar to hierarchical TS-1. In one non-limiting embodiment, a molar composition mixture can be for hierarchical silicate-1 can be 1 PDAMAB-TPHAB: 20 SiO_{2: 2.5} Na₂O: 800 H₂O. In another non-limiting embodiment, the molar composition mixture can be for ZSM-5 can be 1 PDAMAB-TPHAB: 20 SiO₂: 0.5 Al₂O₃: 2.5 Na₂O: 800 H₂O.

In another embodiment, hierarchical zeolite (e.g., ZSM-5) can be prepared made using conventional synthetic zeolite methods. By way of example, a silicon source (e.g., TEOS), templating agent (e.g., tetrapropylammonium hydroxide (TPAOH), and can be agitated at a temperature of 20 to 30° C. until the TEOS is hydrolyzed (e.g., 10 to 48 h, or about 24 h). The hydrolyzed TEOS solution can be added to an aluminum source and agitated until a clear Si/Al synthesis mixture forms (e.g., about 5 to 60 mixture). The aluminum source can be obtained by agitating a solution of an aluminum source (e.g., aluminum isopropoxide (Al(O-i-Pr)₃) base (e.g., NaOH), water, and templating agent (e.g., TPAOH)) until a clear solution forms (e.g., about 1, 2, 3, 4, 5 hours). The Si/Al synthesis mixture can be heated under autogenous pressure (e.g., hydrothermal treatment) at a temperature of at least, equal to, or between 100° C., 110° C., 120° C., 130° C., 140° C., 150° C., 160° C., 170° C., 180° C., 190° C. and 200° C. for a desired amount of time (e.g., 1, 5, 10, 15, 16, 17, 18, 19, 20 hours) to produce a dispersion of Si/Al templated structures (e.g., crystals). The dispersed Si/Al templated structures can be purified (e.g., by repeated centrifugation followed by re-dispersion in water multiple times). The purified Si/Al templated structures can be dried (e.g., at 90 to 120, or about 100° C. under vacuum). The dried powder, can be calcined at a temperature of at least, equal to or between 350° C., 400° C., 450° C., 500° C., 550° C. and 600° C. The heating can be done at a heating rate of 1 to 10° C./min or about 5° C./min in an oxidizing atmosphere (e.g., air, oxygen, or an oxygen enriched air) for until the template molecules are removed (e.g., about 1 to 20 h or about 16 hour) to form the hierarchical zeolite. The resulting hierarchical zeolite can be crystalline, a powder, or a combination of both. In some embodiments, the Si:Al ratio ranges from 30:1 to 50:1. In some embodiments, the Si:Al is 46.76:1.6.

In some embodiments, the hierarchical zeolite can be modified with a linker material. By way of example the hierarchical zeolite can be contacted with a basic linker solution (e.g., an aqueous alcoholic 3-methacryloxyloxypropylsilane (MPS) solution) under agitation for a desired amount of time (e.g., 1 to 80 hours or about 72 hours). The resultant modified hierarchical zeolite can be purified using known zeolite purification methods (e.g., three cycles of centrifugation, decantation, and resuspension in ethanol with ultrasonic bathing), and then dried until a constant weight is obtained. (e.g., 50 to 70° C., or about 60° C.).

2. Monomers or Polymers

The organic polymer used to make shell 104 can be any polymer suitable for forming a porous shell or be formed from the corresponding monomer or blend of monomers. Polymers and/or monomers are available from commercial vendors or made according to conventional chemical reactions. In some embodiments, the polymer is a thermoset polymer, a thermoplastic polymer, a natural-sourced polymer, polyelectrolyte, or a blend thereof. The polymer can also include additives that can be added to the composition. Non-limiting examples, of natural-sourced polymers include starch, glycogen, cellulose, or chitin.

Thermoset polymeric matrices are cured or become cross-linked and tend to lose the ability to become pliable or moldable at raised temperatures. Non-limiting examples of thermoset polymers that can be used to make the porous shell include epoxy resins, epoxy vinylesters, alkyds, amino-based polymers (e.g., polyurethanes, urea-formaldehyde), diallyl phthalate, phenolic polymers, polyesters, unsaturated polyester resins, dicyclopentadiene, polyimides, silicon polymers, cyanate esters of polycyanurates, thermosetting polyacrylic resins, phenol formaldehyde resin (bakelite), fiber reinforced phenolic resins (Duroplast), benzoxazines, or co-polymers thereof, or blends thereof. In addition to these, other thermoset polymers known to those of skill in the art, and those hereinafter developed, can also be used in the context of the present invention. The thermoset polymer can be included in a composition that includes said polymer and additives. Non-limiting examples of additives include coupling agents, antioxidants, heat stabilizers, flow modifiers, etc., or any combinations thereof. In some embodiments, one or more monomers capable of being polymerized when exposed to heat, light or electromagnetic force are used. Such monomers can be precursor materials suitable for forming thermoset polymers. The polymers and/or monomers are available from commercial vendors or made according to conventional chemical reactions.

Thermoplastic polymeric matrices have the ability to become pliable or moldable above a specific temperature and solidify below the temperature. Non-limiting examples of thermoplastic polymers that can be used to make the porous shell include polyacrylates, polyacrylonitrile (PAN), polyethylene terephthalate (PET), a polycarbonate (PC) family of polymers, polybutylene terephthalate (PBT), poly(1,4-cyclohexylidene cyclohexane-1,4-dicarboxylate) (PCCD), glycol modified polycyclohexyl terephthalate (PCTG), poly(phenylene oxide) (PPO), polyalkylene, polyalkylene glycol, polypropylene (PP), polyethylene (PE), polyethylene glycol, polyvinyl chloride (PVC), polystyrene (PS), polymethylmethacrylate (PMMA), thermoplastic polyimides, polyethyleneimine or polyetherimide (PEI) and their derivatives, thermoplastic elastomer (TPE), terephthalic acid (TPA) elastomers, poly(cyclohexanedimethylene terephthalate) (PCT), polyethylene naphthalate (PEN), polyamide (PA), polystyrene sulfonate (PSS), sulfonates of polysulfones, polyether ether ketone (PEEK), polyether ketone ketone (PEKK), acrylonitrile butyldiene styrene (ABS), polyphenylene sulfide (PPS), aryl polyhalides, polyesters, polysaccharide, co-polymers thereof, or blends thereof. In particular instances, polyacrylonitrile (PAN) can be a preferred polymer for making the carbon shells and attachment points. In addition to these, other thermoplastic polymers known to those of skill in the art, and those hereinafter developed, can also be used in the context of the present invention.

Polyelectrolytes include polymers that have an electrolyte group in the repeating unit and having a cationic charge or an anionic charge. Non-limiting examples of cationic polymers that can be used to make the porous shell include homopolymers or copolymers of monomers having a permanent cationic charge or monomers capable of forming a cationic charge in solution upon protonation. Non-limiting examples of permanently cationic monomers include diallyl dimethyl ammonium salts (such as the chloride salt, referred to herein as DADMAC) quaternary ammonium salts of substituted acrylamide, methacrylamide, acrylate and methacrylate, such as trimethylammonium methyl methacrylate, trimethylammonium propyl methacrylamide, trimethylammonium methyl acrylamide, trimethylammonium propyl acrylamide, 2-vinyl N-alkyl quaternary pyridinium, 4-vinyl N-alkyl quaternary pyridinium, (4-vinylbenzyl)trialkylammonium, 2-vinylpiperidinium, 4-vinylpiperidinium, 1-vinyl-3-alkyl-imidazolium, and the ionene (a polymer having ionic groups) class of internal cationic monomers. The counter ion of the cationic co-monomer can be selected from, for example, chloride, bromide, iodide, hydroxide, phosphate, sulfate, hydrosulfate, ethyl sulfate, methyl sulfate, formate, and acetate.

Non-limiting examples of anionic polymers that can be used to make the porous shell include polycarboxylate polymers and copolymers of acrylic acid and maleic anhydride, or alkali metal salts thereof, such as the sodium and potassium salts. Suitable are copolymers of acrylic acid or methacrylic acid with vinyl ethers, such as, for example, vinyl methyl ether, vinyl esters, ethylene, propylene and styrene. Also suitable are polymers containing monomers capable of taking on an anionic charge in aqueous solutions when dissolved in water that has been adjusted to an appropriate pH using an acid, a base a buffer or combination thereof. Non-limiting examples include acrylic acid, maleic acid, methacrylic acid, ethylacrylic acid, dimethylacrylic acid, maleic anhydride, succinic anhydride, vinylsulfonate, cyanoacrylic acid, methylenemalonic acid, vinylacetic acid, allylacetic acid, ethylidineacetic acid, propylidineacetic acid, crotonic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, citraconic acid, vinylbenzoic acid, N-vinylsuccinamidic acid, mesaconic acid, methacroylalanine, acryloylhydroxyglycine, sulfoethyl methacrylate, sulfopropyl acrylate, and sulfoethyl acrylate. Suitable acid monomers also include styrenesulfonic acid, acrylamide methyl propane sulfonic acid, 2-methacryloyloxy-methane-1-sulfonic acid, 3-methacryloyloxy-propane-1-sulfonic acid, 3-(vinyloxy)-propane-1-sulfonic acid, ethylenesulfonic acid, vinyl sulfuric acid, 4-vinylphenyl sulfuric acid, ethylene phosphonic acid and vinyl phosphoric acid. Also suitable are natural anionic polymers such as saccharinic gums such as alginates, xanthates, pectins, carrageenans, guar, carboxymethyl cellulose, and scleroglucans.

In a preferred embodiment, the polymer network of the porous shell includes polyvinyl alcohol (PVA), poly (N-isopropyl acrylamide) (pNIPAAm), poly(ethylene glycol), a poly(methylmethacrylate) (PMMA), a hydroxylated polymethacrylate, an ethylene-vinyl acetate copolymer, polyhydroxyethylmethacrylate, poly(maleic acid/octyl vinyl ether) (PMAOVE), a polyurethane, poly(acrylic acid), poly(stearyl acrylate) (PSA), polystyrene (PS), polyvinylpyrrolidone (PVP), poly(acrylamide) and copolymers thereof such as dipropylene glycol acrylate caprylate (DGAC) or dipropylene glycol diacrylate sebacate (DGDS) (a cross-linker), starch, chitosan or a derivative thereof, silicone or a derivative thereof, or a polyolefin, or any combination thereof.

3. Active Agents

Active agent 106 can include one active agent or two or more different active agents. By way of example, agent 106 in micropore 108 of zeolite core 102 can be the same or different than agent 106 in mesopore 110 or shell 102.

### i. Chemical Agents

Chemical agents include reactive and non-reactive agents. Reactive agents are chemicals that under a chemical reaction in the presence of another chemical or stimulus. Non-reactive chemical agents do not react in the presence of another chemical or stimulus. All types of chemical agents can be used in the context of the present invention. Non-limiting examples of chemical agents include adhesives, dyes (e.g., inks, thermochromics, etc.), cosmetic agents (e.g., cosmetic ingredients described in the CTFA International Cosmetic Ingredient Dictionary and Handbook (2004 and 2008)), pharmaceutical ingredients, pesticides, herbicides, phase-change materials, self-healing coatings, visual indicators, nanoparticles (metal or non-metal particles), imaging agents, catalysts (organic, inorganic, and organometallic), sealants, hormones, fragrances (artificial and natural chemicals, liquids, oils, etc.), dyes and color ingredients (e.g., Blue 1, Blue 1 Lake, Red 40, titanium dioxide, D&C blue no. 4, D&C green no. 5, D&C orange no. 4, D&C red no. 17, D&C red no. 33, D&C violet no. 2, D&C yellow no. 10, and D&C yellow no. 11), adsorbents, lubricants, solvents, moisturizers (including, e.g., emollients, humectants, film formers, occlusive agents, and agents that affect the natural moisturization mechanisms of the skin), water-repellants, UV absorbers (physical and chemical absorbers such as paraaminobenzoic acid (“PABA”) and corresponding PABA derivatives, titanium dioxide, zinc oxide, etc.), vitamins (e.g. A, B, C, D, E, and K), trace metals (e.g., zinc, calcium and selenium), anti-irritants (e.g., steroids and nonsteroidal anti-inflammatories), antioxidants (e.g., BHT and tocopherol), chelating agents (e.g., disodium EDTA and tetrasodium EDTA), preservatives (e.g., benzoic acid, sodium benzoate, hydroxybenzoate, lactic acid, nitrite, nitrates, propionic acid, sodium propionate, sulfur dioxide, fulfities, sorbic acid, sodium sorbate, methylparaben and propylparaben), pH adjusters or buffers (e.g., sodium hydroxide, hydrochloric acid, and citric acid, and phosphates), absorbents (e.g., aluminum starch octenylsuccinate, kaolin, corn starch, oat starch, cyclodextrin, talc, and zeolite), skin bleaching and lightening agents (e.g., hydroquinone and niacinamide lactate), humectants (e.g., sorbitol, urea, and manitol), exfoliants, waterproofing agents (e.g., magnesium/aluminum hydroxide stearate), and skin conditioning agents (e.g., aloe extracts, allantoin, bisabolol, ceramides, dimethicone, hyaluronic acid, and dipotassium glycyrrhizate).

### ii. Pharmaceutical Agents

Non-limiting examples of pharmaceutical active agents include adjuvants, anti-acne agents, agents used to treat rosacea, analgesics, anesthetics, anorectals, antihistamines, anti-inflammatory agents including nonsteroidal anti-inflammatory drugs, antibiotics, antifungals, antivirals, antimicrobials, anti-cancer actives, scabicides, pediculicides, antineoplastics, antiperspirants, antipruritics, antipsoriatic agents, anti seborrheic agents, biologically active proteins and peptides, burn treatment agents, cauterizing agents, depigmenting agents, depilatories, diaper rash treatment agents, enzymes, hair growth stimulants, hair growth retardants including DFMO and its salts and analogs, hemostatics, kerotolytics, canker sore treatment agents, cold sore treatment agents, dental and periodontal treatment agents, photosensitizing actives, skin protectant/barrier agents, steroids including hormones and corticosteroids, sunburn treatment agents, sunscreens, transdermal actives, nasal actives, vaginal actives, wart treatment agents, wound treatment agents, wound healing agents, etc.

### iii. Nanoparticle Agents

Non-limiting examples of nanoparticles include metal particles, metal oxides, or alloys thereof, quantum dots of organic and inorganic materials, particle shaped 2D materials (small flakes) or any combination thereof. Metal particles can include alkali metals, alkaline earth metals, noble metals (e.g., gold, platinum, palladium), and transition metals (e.g., silver, chromium, copper, nickel, cobalt lanthanides and the like).

### iv. Biological Agents

Biological agents include pathogens (e.g., a bacterium, a virus, a protozoan, a parasite, a fungus or prion), proteins, anti-microbial agents, DNA., microorganism, cells (e.g., a prokaryotic cell, a eukaryotic cell, a tumor cell and the like), antibodies (e.g., poly- and/or monoclonal), antibody fragments, antibody-drug conjugates, hormones (e.g., peptidic hormone, such as insulin or growth hormone, or a lipid hormone, such as a steroid hormone, for example prostaglandin and estrogen), polypeptides (e.g., a protein or a protein having catalytic activity, for example having ligase, isomerase, lyase, hydrolase, transferase or oxidoreductase activity), etc.

Non-limiting examples of viruses include adenoviridae (e.g., adenovirus), herpesviridae (e.g., Herpes simplex, type 1 and type 2, and Epstein-barr), papillomaviridae (e.g., human papillomavirus), hepadnaviridae (e.g., Hepatitis B), flaviviridae (e.g., Hepatitis C, yellow fever, dengue, West Nile), retroviridae (e.g., immunodeficiency virus (HIV)), orthomyxoviridae (e.g., Influenza), paramyxoviridae (e.g., measles, mumps), rhabdoviridae (e.g., rabies), and reoviridae (e.g., rotavirus).

Non-limiting examples of bacterium include gram-positive bacterium and a gram-negative bacterium. Non-limiting examples of gram-positive bacteria include Corynebacterium, Mycobacterium, Nocardia, Streptomyces, Staphylococcus (such as S. aureus), Streptococcus (such as S. pneumoniae), Enterococcus (such as E. faecium), Bacillus, Clostridium (such as a dill) and Listeria. Non-limiting examples of gram negative bacteria include Hemophilus, Klebsiella, Legionella, Pseudomonas, Escherichia (such as E. coli), Proteus, Enterobacter, Serratia, Helicobacter (such as Holicobacter pylon), and Salmonella.

### v. Oils and Extracts

Oils and extracts can be classified in the following categories: (i) essential oils; (ii) aroma chemicals; (iii) absolutes; (iv) balsams; (v) concentrated oils; (vi) essences; (vii) extracts; (viii) resins; and (ix) infusions. Botanical extracts (e.g., aloe vera, chamomile, cucumber extract, ginkgo biloba, ginseng, and rosemary) can be used as an active agent in the context of the present invention. Essential oils include oils derived from herbs, flowers, trees, and other plants. Such oils are typically present as tiny droplets between the plant's cells, and can be extracted by several methods known to those of skill in the art (e.g., steam distilled, enfleurage (i.e., extraction by using fat), maceration, solvent extraction, or mechanical pressing). Typical physical characteristics found in essential oils include boiling points that vary from about 160° C. to 240° C. and densities ranging from about 0.759 to about 1.096. Loading an oil and/or an extract in the zeolite core can inhibit evaporation of the oil and/or oxidation of the oil. Oxidation of the oil can be inhibited when the composite material is made from an opaque material or a material that includes a UV blocker.

Essential oils typically are named by the plant from which the oil is found. For example, rose oil or peppermint oil is derived from rose or peppermint plants, respectively. Non-limiting examples of essential oils that can be used in the context of the present invention include sesame oil, macadamia nut oil, tea tree oil, evening primrose oil, Spanish sage oil, Spanish rosemary oil, coriander oil, thyme oil, pimento berries oil, rose oil, anise oil, balsam oil, bergamot oil, rosewood oil, cedar oil, chamomile oil, sage oil, clary sage oil, clove oil, cypress oil, eucalyptus oil, fennel oil, sea fennel oil, frankincense oil, geranium oil, ginger oil, grapefruit oil, jasmine oil, juniper oil, lavender oil, lemon oil, lemongrass oil, lime oil, mandarin oil, marjoram oil, myrrh oil, neroli oil, orange oil, patchouli oil, pepper oil, black pepper oil, petitgrain oil, pine oil, rose otto oil, rosemary oil, sandalwood oil, spearmint oil, spikenard oil, vetiver oil, wintergreen oil, ylang ylang, or any combination thereof. Other essential oils known to those of skill in the art are also contemplated as being useful within the context of the present invention.

### vi. Fragrant Chemical Compounds

Chemical compounds that impart a fragrance/odor can be used. For example, limonene, carvone, isoamyl benzoate, methyl heptine carbonate, triacetin, anethole, methyl isoeugenol, safrole, diphenyl oxide, benzyl propionate, eugenol acetate, phenylethyl acetate, cinnamyl acetate, propiophenone, p-cresyl acetate, p-methyl acetophenone, benzyl acetate, ethyl acetoacetate, ethyl benzoate, isosafrole, ethyl cinnamate, acetophenone, benzyl benzoate, p-methyoxy acetophenone, methyl cinnamate, benzyl formate, methyl benzoate, 2-undecanone, ethyl laurate, isoamyl isovalerate, 2-nonanone, linalyl acetate, octyl acetate, phenyl methyl carbonyl propionate, isoamyl butyrate, menthyl acetate, menthone, phenyl methyl carbonyl acetate, terpinyl acetate, thuj one, ethyl caprylate, fenchone, geranyl acetate, bornyl acetate, pulegone, p-cresyl ethyl ether, methyl eugenol, piperitone, jasmine, methyl chavicol, dibenzyl ether or any combination thereof. Other fragrant chemical compounds known to those of skill in the art are also contemplated as being useful within the context of the present invention.

### vi. Energy Storage Compounds

Chemical compounds that can be used in energy storage devices can be used. By way of example the agent(s) can include sulfur, metal sulfides, and metal polysulfides. Non-limiting examples of metal sulfides and polysulfides include lithium sulfide and lithium polysulfide.

### D. Uses and Methods of Controlled/Slow/Diffusive Release

The controlled-release core/shell composite materials of the present invention can be used in a variety of applications. By way of example, the core/shell composite materials can be comprised in a composition and the composition can be topically, transdermally, or orally administered to a subject. Alternatively, the composition can be applied to a surface of an inanimate object. As exemplified in the Examples section and described throughout the specification, the active agent can be released from the core/shell composite material when subjected to a specific stimulus. Compositions that include the core/shell composite material of the present invention can include a pharmaceutical composition, a topical skin care composition, or a composition intended to be applied to an inanimate object. Non-limiting examples of uses of the core/shell composite material of the present invention include fragrance release and cosmetics, drug delivery, bioanalysis, diagnostics, sensors & markers, energy storage, bio-inhibitors (repellants pesticides, herbicides), urea release, self-repair (paints, paper, textile, concrete, etc.), flame retardants, personal care (skin, hair, teeth, etc.), nutritional additives, vitamins, flavors, pigments, textile scent and care (detergents, softeners, etc.), industrial odors, animal care and the like.

In other instances, the active agent loaded core/shell composite material is intended for use in chemical reactions. By way of example, upon being subjected to a proper stimulus, the core/shell composite material can release a first active agent, which reacts with a second active agent to form a new product. In another example, the first agent can be released and interact with a second agent to activate the second agent. Non-limiting examples of stimuli include pH range, electromagnetic radiation, a temperature range, a mechanical force (e.g., application or removal of pressure, a sudden change in pressure, shear force, rubbing action, squeezing and/or pulsating forces), humidity, the presence or absence of a chemical substance, an odor, or any combination thereof. A pH can be changed from acid to base or vice versa. By way of example, a pH can be changed from 1 to 12, 2 to 8, 2 to 4, 8 to 12, 12 to 5, 10 to 3, or 8 to 5. Electromagnetic radiation can include ultraviolet radiation, visible light, infrared radiation, or any combination thereof. Sources of electromagnetic radiation can include the sun and/or lamps (e.g., UV, UV/visible, visible lamps). Temperature ranges can be any range, preferably 25° C. to 100° C., or 30° C. to 80° C., or 40° C. to 60° C., or 25° C., 30° C., 35° C., 40° C., 45° C., 50° C., 55° C., 60° C., 65° C., 70° C., 75° C., 80° C., 85° C., 90° C., 95° C., 100° C., or any range or value there between.

In some embodiments, the active agent loaded core/shell composite material present invention can be included in articles of manufacture, made into sheets, films, or incorporated into membranes. The sheet or film can have a thickness of 10 nm to 500 μm. The article of manufacture can be an energy storage device, a transport or conversion device, an actuator, a piezoelectric device, a sensor, a smart textile, a flexible device, an electronic device, an optical device, an optoelectronic device, an electro-optical device, a plasmonic device, a delivery device, a polymer nanocomposite, an actuating device, a MEMS/NEMS device, a logic device, a filtration/separation device, a capturing device, an electrochemical device, a display device, etc. In some embodiments, the article of manufacture is a virtual reality device, an augmented reality device, a fixture that requires flexibility such as an adjustable mounted wireless headset and ear buds, a communication helmet with curvatures, a medical patch, a flexible identification card, a flexible sporting good, a packaging material and applications where the energy source can simply final product design, engineering and mass production. In a non-limiting embodiment, the active agent loaded core/shell composite material can be used in a Li-S battery as an electrode (e.g., a cathode and/or anode).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

Characterization of samples were performed using the following instrumentation: scanning electron microscopy (SEM): FEI Nova NanoSEM™ (ThermoFisher Scientific, USA); energy-dispersive X-ray spectroscopy (EDS): FEI Nova NanoSEM operated at 10-20 kV; X-ray diffraction (XRD): powder PANalytical Empyrean diffractometer (PANalytical, the Netherlands); FT-IR spectra: Nicolet iS10 FT-IR spectrometer (ThermoFisher Scientific, USA); transmission electron microscopy (TEM): Titan Twin TEM (ThermoFisher Scientific, USA); operating at 120 kV; thermal gravimetric analysis (TGA): TGA Q500 (TA Instruments, U.S.A.) from 25 to 800° C. with a heat ramp of 10° C./min under nitrogen atmosphere; surface area and pore size was determined based on Barrett-Joyner-Halenda (BJH) and Horvath±Kawazoe (HK) calculation, using a nitrogen absorption-desorption isotherm at 77 K on an automatic volumetric adsorption apparatus (Micromeritics ASAP 2420, Micromeritics, USA).

### Example 1

### Synthesis of Hierarchical Zeolites

Meso-ZSM-5 was synthesized as described in steps A-F below following the procedure of Zhou et al. (“Synthesis of mesoporous ZSM-5 zeolite crystals by conventional hydrothermal treatment.” RSC Advances 2013, 3(36): 15596-15599).

A. Preparation of silicate solution: Tetraethylorthosilicate (TEOS, 52 g, Sigma-Aldrich®, U.S.A), tetrapropylammonium hydroxide (TPAOH, 15.5 mL of 1 M in H₂O, 20%, Sigma-Aldrich®) and water (150 mL) were added to a polypropylene bottle, which was placed on shaker for 24 h to hydrolyze the TEOS at room temperature and obtain a clear solution.

B. Preparation of aluminate solution. After about 22 h of the TEOS hydrolysis in step A, aluminum isopropoxide (Al(O-i-Pr)₃, 2 g), NaOH (0.4 g in 10 ml of H₂O), water (135 mL) and TPAOH (15.5 mL) were added to a glass beaker and stirred for about 2 h until a clear aluminate solution formed.

C. Preparation of synthesis mixture. The clear silicate solution of step A was added to the clear aluminate solution of Step B under strong stirring. The stirring of the resulting clear solution was continued for about 10 minutes in total.

D. Hydrothermal treatment. A 600 mL polytetrafluoroethylene lined autoclave equipped with magnetic stirring was filled with the synthesis mixture of step C. The autoclave was sealed and placed in an oil bath kept at 160° C. for 16 h.

E. Product purification. After cooling the autoclave to room temperature, it was opened and the synthesis mixture containing dispersed crystals was removed from the autoclave. The dispersed crystals were purified by repeated centrifugation followed by re-dispersion in water for four times in total. The purified crystals were dried at 100° C. under vacuum. For synthesis containing aluminum, crystals also formed on the walls of the autoclave. 8.3 g of white powder was obtained.

F. Calcination. The powder of step E (5.9 g) was calcined at 500° C. (the heating rate was 5° C./min) in air for 16 h to remove the template molecules and obtain a the hierarchical zeolite as a white powder (5.12 g).

### Example 2

### Characterization of the Hierarchical Zeolite of Example 1

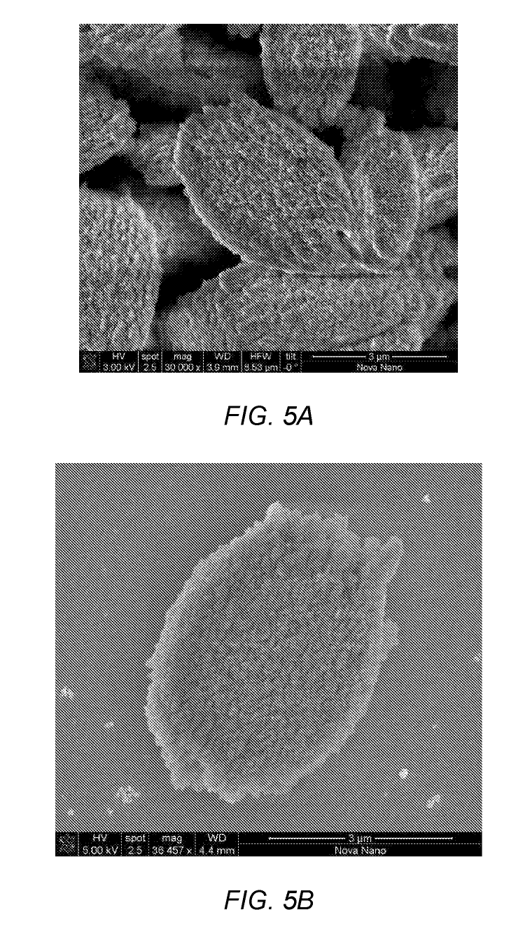

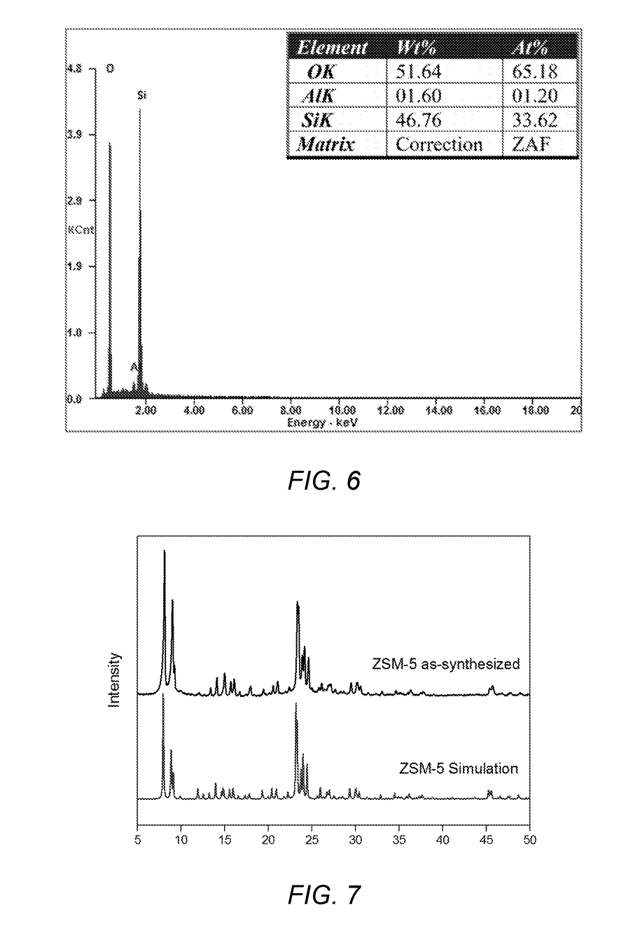

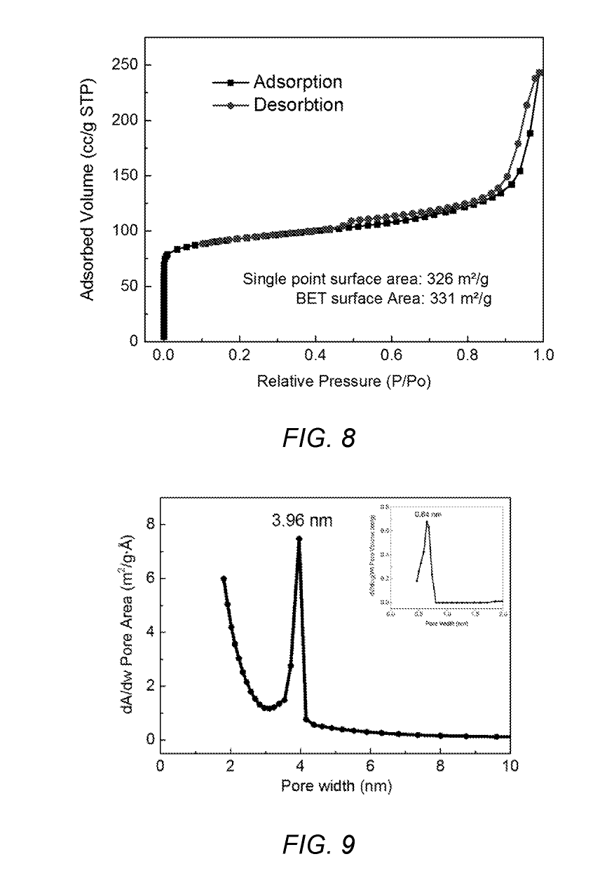

FIGS. 5A and 5B show the SEM images of meso-ZSM-5 before and after calcination. Using energy-dispersive X-ray spectroscopy (See, FIG. 6) the Si:Al weight ratio was determined to be Si: Al is 46.76:1.6.The XRD pattern of meso-ZSM-5 as-synthesized (See, FIG. 7) matched with the simulated XRD pattern, which indicated that the synthesized particles are ZSM-5. FIG. 8 shows the nitrogen absorption-desorption isotherm of meso-ZSM-5. The specific surface area is around 331 m²/g. FIG. 9 shows the pore size distributions of ZSM-5 as-synthesized. The mesopore size was determined to be about 4.96 nm and the micropore size was determined to be 0.64 nm based on BJH and HK calculation, which means a hierarchical zeolite was synthesized.

### Example 3

### Synthesis of MPS Modified Meso-ZSM-5

Modification of meso-ZSM-5: Meso-ZSM-5(1 g) was dispersed in mixture of ethanol (50 mL), H₂O (5 mL) and ammonium aqueous solution (1 mL of 25%) by ultra-sonication for about 0.5 h. 3-(Methacryloyloxy)propyltrimethoxysilane (MPS, 2 mL) was added into dispersion and the reaction was continued further for 72 h with stirring. The resultant silica particles were then purified by three cycles of centrifugation, decantation, and re-suspension in ethanol with ultrasonic bathing. The modified meso-ZSM-5 was dried in a vacuum oven at 60° C. till constant weight.

### Example 4

### Characterization of the Modified Hierarchical Zeolite of Example 3

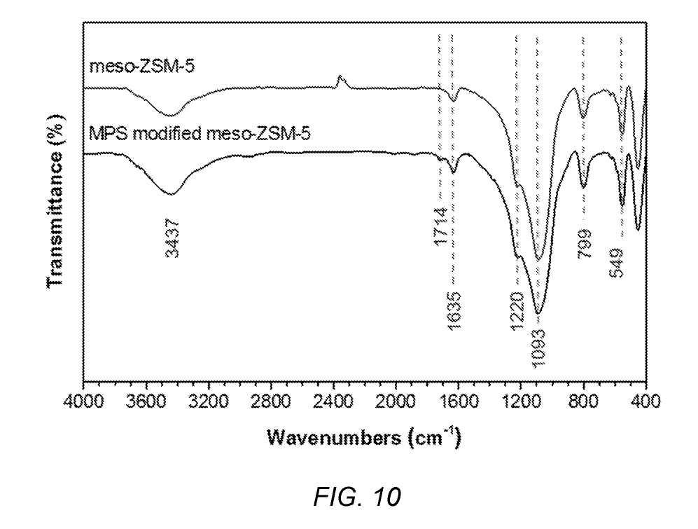

The FT-IR spectra of unmodified and modified meso-ZSM-5 are shown in FIG. 10. The absorption band around 799 cm⁻¹ was due to Si—O—Si symmetric stretching, and absorption band around 1093 and 1220 cm⁻¹ were assigned to asymmetric stretching of Si—O—Si. The absorption bands at 3437 and 1635 cm⁻¹ were due to the H—O—H stretching and bending modes of the absorbed water, respectively. The band around 549 cm⁻¹ was assigned to the vibration of double 5-rings in MFI lattice. In the spectra of modified silica particles, the absorption at 1714 cm⁻¹ was related to the C═O functional groups of MPS.

### Example 5

### Preparation of Core/Shell Composite Material of the Present Invention

Synthesis of meso-ZSM-5@polystyrene core-shell (meso-ZSM-5@PS) particles: Meso-ZSM-5-MPS (0.2 g) of Example 3 was dispersed in ethanol (100 mL and dispersed using a Soinc Dismembrator (Fisher Scientific, Model 550, 50%, 30/30). Polyvinylpyrrolidone (PVP, 0.5 g, MW=40,000, Sigma-Aldrich®), azobisisobutyronitrile (AIBN, 0.1 g, Sigma-Aldrich®), styrene (0.6 mL, Sigma-Aldrich®) and 1,4-divinylbenzene (0.1 mL, Sigma-Aldrich®) was added to the dispersion. After bubbling nitrogen through the dispersion for 30 min, the dispersion was heated at 75° C. for 24 h with stirring to from a 1,4-divinylbenzene cross-linked polystyrene shell around the Meso-ZSM-5-MPS core (meso-ZSM-5@PS). The resultant particles were then purified by three cycles of centrifugation, decantation, and re-suspension in ethanol with ultrasonic bathing. The resulting meso-ZSM-5@PS was dried in a vacuum oven at 60° C. overnight.

### Example 6

### Characterization of the Meso-ZSM-5@PS of Example 5

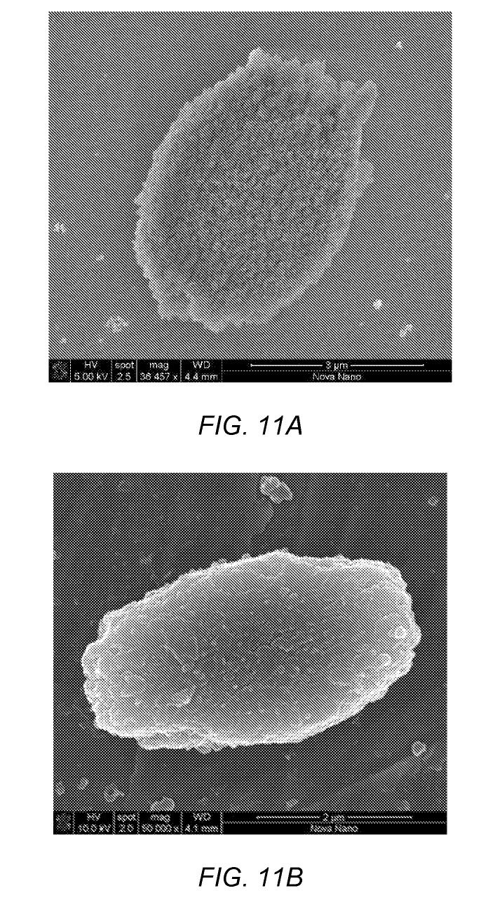

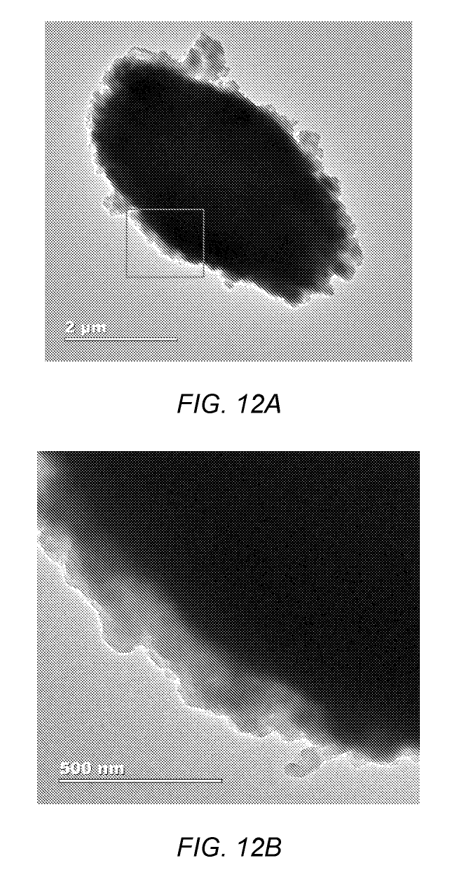

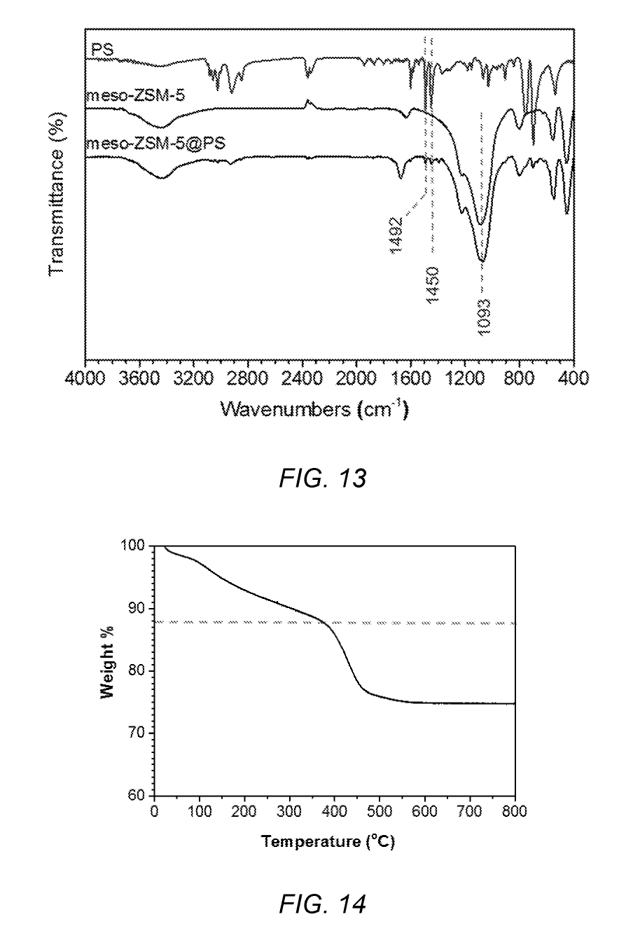

FIGS. 11A and 11B show the SEM images of meso-ZSM-5 and meso-ZSM-5@PS. From the SEM images, it was determined that the surface of meso-ZSM-5@PS was smoother than meso-ZSM-5 due to polystyrene shell. FIG. 12A shows the TEM image of meso-ZSM-5@PS and FIG. 12B is the magnified part FIG. 12A (square), which clearly shows a polymer shell covered on the surface of meso-ZSM-5. Thus, a core-shell structure was formed. From EDS mapping (not shown), it was determined that the ZSM-5 was encapsulated by the polystyrene shell. FIG. 13 shows the FT-IR spectra of PS (polystyrene), meso-ZSM-5 and meso-ZSM-5@PS. The peaks at 1492 cm⁻¹ and 1450 cm⁻¹ were attributed aromatic C═C stretching, which were from benzene ring of polystyrene. The absorption band at 1093 cm⁻¹ was ascribed to the stretching vibration of Si—O—Si groups. When compared with the FT-IR of meso-ZSM-5 and PS, the synthesized meos-ZSM-5@PS had the characteristic peaks of PS and meso-ZSM-5, which meant the final product was a composite of meso-ZSM-5 and polystyrene.

### Example 7

### Loading of Chemical Agent by Core/Shell Composite Material of the Present Invention

The meso-ZSM-5@PS of Example 5 (0.1 g) was dispersed in a chemical agent (limonene, 0.5 mL, Sigma-Aldrich®) by sonication for 45 min. The limonene loaded meso-ZSM-5@PS was separated by centrifuge and let it dry at room temperature overnight. The loading of limonene was tested by thermogravimetric analysis (TGA). FIG. 14 shows the TGA of limonene loaded meso-ZSM-5@PS. From this analysis it was determined that the limonene loading was around 12%.

### Prophetic Example 8

### Addition of Active Agents to Hierarchical Zeolite Core

Meso-TS-1, meso-Silicalite-1, meso-Beta and meso-ZSM-5 will be synthesized following the procedure of Tian et al.

### Example 9

### Addition of Active Agents to Hierarchical Zeolite Core

Rose essence (1 g, active agent) and hierarchical ZSM-5 core (2 g) of Example 8 will be dispersed in water (50 mL) using ultrasonication. The mixture will be evacuated by means of vacuum pump for 30 min and repeated three times to ensure adequate loadings of fragrance molecules in the core. The mixture will then be centrifuged at 1,000 rpm for 20 min. The supernatant will be removed and the fragrance loaded hierarchical ZSM-5 core will be obtained.

### Example 10

### Preparation of Core/Shell Composite Material of the Present Invention

Fragrance loaded hierarchical ZSM-5 core of Example 9 (2 g) will be immersed in polyacrylic acid (20 mL, PAA, Mw=50,000 g/mol) solution for 20 min. Then resulting coated fragrance loaded hierarchical ZSM-5 core will be separated by centrifugation followed by drying at 45° C. for 24 h to produce the fragrance loaded hierarchical ZSM-5 core/polymer shell composite material of the present invention.

1. A controlled-release core/shell composite material comprising:
(a) a hierarchical structured zeolite core having at least a bimodal pore structure with a first active agent loaded into pores of the core; and
(b) a porous polymeric outer shell that substantially encompasses the zeolite core, wherein the composite material is configured to controllably release the first active agent from the zeolite core and the porous polymeric shell in response to at least one stimulus.

2. The controlled-release core/shell composite material of claim 1, wherein the hierarchical structured zeolite core has a bimodal microporous-mesoporous structure.

3. The controlled-release core/shell composite material of claim 2, wherein the first active agent is loaded into the micropores and/or mesopores of the zeolite core.

4. The controlled-release core/shell composite material of claim 2, further comprising at least one additional active agent, wherein the first active agent and at least one additional active agent are each loaded into the micropores and/or mesopores of the zeolite core, the shell or combinations thereof, and wherein the first and the additional active agent are:
(i) different active agents;
(ii) have different sizes with the first active agent being smaller in size than the second active agent; and/or
(iii) capable of reacting with one another upon their release from the composite material to form an activated material.

5. The controlled-release core/shell composite material of claim 1, wherein the hierarchical structured zeolite core is a meso-titanium silicate-1 (TS-1) zeolite core, a meso-silicalite-1 zeolite core, or a ZSM-5 zeolite core, and optionally, the zeolite core and/or the polymeric shell is/are functionalized.

6. The controlled-release core/shell composite material of any one of claim 1, wherein the porous polymeric shell comprises a polymer network of hydrophilic, hydrophobic, amphiphilic, amphiphobic, lipophilic or lipophobic, oleophilic or oleophobic polymers, or a combination thereof.

7. The controlled-release core/shell composite material of claim 6, wherein the polymer network comprises polyvinyl alcohol (PVA), poly (N-isopropyl acrylamide) (pNIPAAm), poly(ethylene glycol), a poly(methylmethacrylate) (PMMA), a hydroxylated polymethacrylate, an ethylene-vinyl acetate copolymer, polyhydroxyethylmethacrylate, poly(maleic acid/octyl vinyl ether) (PMAOVE), a polyurethane, poly(acrylic acid), poly(stearyl acrylate) (PSA), polystyrene (PS), polyvinylpyrrolidone (PVP), poly(acrylamide) Poly(ethylene glycol) methyl ether acrylate, Poly(ethylene glycol) methyl ether acrylate and copolymers thereof such as dipropylene glycol acrylate caprylate (DGAC) or dipropylene glycol diacrylate sebacate (DGDS) (a cross-linker), starch, chitosan or a derivative thereof, silicone or a derivative thereof, or a polyolefin, or any combination thereof.

8. The controlled-release core/shell composite material of claim 7, wherein the polymer network comprises poly(acrylic acid) and the hierarchical structured zeolite core is a ZSM-5 core having a bimodal microporous-mesoporous structure.

9. The controlled-release core/shell composite material of claim 8, wherein the polymeric network comprises neutral, hydrogen bonded, cationic, anionic, or zwitterionic polymers or polymers comprising metal-organic frameworks or zeolitic imidazolate frameworks.

10. The controlled-release core/shell composite material of claim 1, wherein the at least one stimulus is a pH range, electromagnetic radiation, a temperature range, a mechanical force, humidity, the presence or absence of a chemical substance, an odor, electrical charge, electrostatic charge, or any combination thereof.

11. The controlled-release core/shell composite material of claim 1, wherein the shell is capable of expanding, contracting, constricting, eroding, deforming, reacting, compressing or cyclic compressing, folding, or dissolving in response to the stimulus.

12. The controlled-release core/shell composite material of claim 1, wherein the active agent is a chemical agent, a biological agent, an oil, an ionic liquid, a suspension, an emulsion, or a polymer, or any combination thereof.

13. The controlled-release core/shell composite material of claim 12, wherein:
the chemical agent is a metallo-organic system, a fragrance-producing chemical, a flavoring agent, a drug, a cosmetic agent, a malodor agent, a reactive agent, a cross-linker, a reactive diluent, a solvent, an inorganic or organic chemical, a petrochemical, a reducing or oxidizing agent, or an aqueous salt, or any combination thereof; and/or
the biological agent is a protein, a peptide, a nucleic acid, a carbohydrate, a lipid, or any combination thereof.

14. The controlled-release core/shell composite material of claim 13, wherein the composite material is comprised in a pharmaceutical composition, a topical skin care composition, a composition intended to be applied to an inanimate object, or a device.

15. The controlled-release core/shell composite material of claim 1, wherein the zeolite core comprises at least 80 wt. % of zeolite, based on the total weight of the core, and up to 20 wt. % of active agent, based on the total weight of the core.

16. A method of using the controlled-release core/shell composite material of claim 1 to deliver an active agent, the method comprising subjecting the composite material to a stimulus to release and deliver the active agent.

17. A device comprising a sulfur-containing active agent loaded core/shell composite material.

18. The device of claim 17, wherein the device is a lithium sulfide battery.

19. A method of making the controlled-release core/shell composite material of claim 1, the method comprising:
(a) obtaining an hierarchical structured zeolite core having at least a bimodal pore structure; and
(b) loading the zeolite core with an active agent prior to or after forming a porous polymer shell.

20. The method of claim 19, wherein forming the porous polymer shell comprises:
(i) coating the zeolite core with a polymer containing solution followed by drying the coated zeolite core to form the core/shell composite material and/or (ii) coating the zeolite core with a monomeric containing solution, polymerizing the monomers to form a polymer coating on the zeolite core, and then drying the coated zeolite core.
